(19) United States
(12) Patent Application Publication
(10) Pub. No.: US 2023/0059554 A1
(43) Pub. Date: Feb. 23, 2023

(54) SATELLITE CONSTELLATION FORMING SYSTEM, SATELLITE CONSTELLATION FORMING METHOD, GROUND FACILITY, BUSINESS DEVICE, AND OPEN ARCHITECTURE DATA REPOSITORY

(71) Applicant: Mitsubishi Electric Corporation, Tokyo (JP)

(72) Inventor: Hisayuki MUKAE, Tokyo (JP)

(73) Assignee: Mitsubishi Electric Corporation, Tokyo (JP)

(21) Appl. No.: 17/792,402

(22) PCT Filed: Mar. 9, 2021
(86) PCT No.: PCT/JP2021/009112

§ 371 Date: Jul. 13, 2022

(30) Foreign Application Priority Data
Mar. 10, 2020 (JP) 2020-040880

(51) Int. Cl. B64G 1/68; B64G 1/10; H04B 7/185

(52) U.S. Cl. CPC B64G 1/68; B64G 1/10; H04B 7/18521

(57) ABSTRACT

A satellite constellation forming system (600) forms a satellite constellation having a plurality of orbital planes in each of which a plurality of satellites fly at the same average orbital altitude. A satellite constellation forming unit (11) forms a passage region for a space object to pass through before the space object passes through an orbital altitude of the satellite constellation from above the satellite constellation. After the space object has passed through the passage region, the satellite constellation forming unit (11) restores the satellite constellation to a state before the passage region is formed.

### TECHNICAL FIELD

The present disclosure relates to a satellite constellation forming system, a satellite constellation forming method, a satellite constellation forming program, a ground facility, a business device, and an open architecture data repository.

### BACKGROUND ART

In recent years, large-scale satellite constellations including several hundred to several thousand satellites, which are called mega-constellations, have started to be constructed, and the risk of collision between satellites in orbit is increasing. In addition, space debris such as an artificial satellite that has become uncontrollable due to a failure or rocket debris has been increasing.

With the rapid increase in space objects such as satellites and space debris in outer space as described above, in space traffic management (STM) there is an increasing need to create international rules for avoiding collisions between space objects.

In particular, there is a plan to build a mega-constellation composed of a satellite group of several thousand satellites in the vicinity of an orbital altitude of 340 km. On the other hand, the International Space Station (ISS) is normally flying at an orbital altitude of about 400 km. The ISS is expected to complete its mission in or after the latter half of the 2020s. After completing the mission, the ISS needs to be made to deorbit and enter the atmosphere for post mission disposal (PMD).

Patent Literature 1 discloses a technology for forming a satellite constellation composed of a plurality of satellites in the same circular orbit.

### CITATION LIST

### Patent Literature

Patent Literature 1: JP 2017-114159 A

### SUMMARY OF INVENTION

### Technical Problem

The ISS is a large-scale space object and is equipped with many solar array wings which are large in area. Such solar array wings are subject to aerodynamic drag of the atmosphere in a region to pass through during an orbital descent. There is a high risk that due to aerodynamic drag the ISS will descend at a timing or speed different from a predicted orbit, causing an error in a predicted location. If the ISS passes through the vicinity of 340 km in deorbiting and descending for PMD, there is a risk of collision with the satellite group constituting the mega-constellation. In addition, there is already aerodynamic drag at an orbital altitude of about 340 km. There is a risk that due to an unexpected error in orbit control caused by this aerodynamic drag, control from the ground may have no effect on the ISS.

However, Patent Literature 1 does not describe a collision avoidance method for a case in which a large-scale space object intrudes into a satellite constellation.

An object of the present disclosure is to reduce a risk of collision between a large-scale space object, such as the ISS, and a satellite constellation.

### Solution to Problem

A satellite constellation forming system according to the present disclosure forms a satellite constellation having a plurality of orbital planes in each of which a plurality of satellites fly at a same average orbital altitude, and the satellite constellation forming system includes

a satellite constellation forming unit to form a passage region for a space object to pass through at an orbital altitude of the satellite constellation by controlling a relative angle in an azimuth direction between orbital planes of the plurality of orbital planes before the space object passes through the orbital altitude of the satellite constellation from above the satellite constellation, and after the space object has passed through the passage region, restore the satellite constellation to a state before the passage region is formed by restoring the relative angle in the azimuth direction between orbital planes of the plurality of orbital planes.

### Advantageous Effects of Invention

A satellite constellation forming system according to the present disclosure forms a passage region for a space object to pass through at an orbital altitude of a satellite constellation, so that a risk of collision between a large-scale space object and the satellite constellation can be reduced.

### BRIEF DESCRIPTION OF DRAWINGS

FIG. 1 is an example in which a plurality of satellites cooperatively realize a communication service to the ground over the entire globe of Earth;

FIG. 2 is an example in which a plurality of satellites in a single orbital plane realize an Earth observation service;

FIG. 3 is an example of a satellite constellation having a plurality of orbital planes that intersect in the vicinity of the polar regions;

FIG. 4 is an example of a satellite constellation having a plurality of orbital planes that intersect outside the polar regions;

FIG. 5 is a configuration diagram of a satellite constellation forming system;

FIG. 6 is a configuration diagram of a satellite of the satellite constellation forming system;

FIG. 7 is a configuration diagram of a ground facility of the satellite constellation forming system;

FIG. 8 is an example of a functional configuration of the satellite constellation forming system;

FIG. 9 is a flowchart of a satellite constellation forming process by the satellite constellation forming system according to Embodiment 1;

FIG. 10 is a diagram of 12 orbital planes of a satellite constellation composed of 24 orbital planes according to Embodiment 1 as seen from a direction of the North Pole;

FIG. 11 is 12 orbital planes other than the 12 orbital planes of FIG. 10;

FIG. 12 is a total of 24 orbital planes resulting from combining the 12 orbital planes of FIG. 10 and the 12 orbital planes of FIG. 11;

FIG. 13 is a diagram in which a passage region is formed in the satellite constellation of FIG. 10;

FIG. 14 is a diagram in which a passage region is formed in the satellite constellation of FIG. 11;

FIG. 15 is a diagram in which a passage region is formed in the satellite constellation of FIG. 12;

FIG. 16 is a configuration diagram of the satellite constellation forming system according to a variation of Embodiment 1;

FIG. 17 is a diagram of 12 orbital planes of a satellite constellation composed of 24 orbital planes according to Embodiment 2 as seen from a direction of the North Pole;

FIG. 18 is 12 orbital planes other than the 12 orbital planes of FIG. 17;

FIG. 19 is a total of 24 orbital planes resulting from combining the 12 orbital planes of FIG. 17 and the 12 orbital planes of FIG. 18;

FIG. 20 is a diagram in which a passage region is formed in the satellite constellation of FIG. 17;

FIG. 21 is a diagram in which a passage region is formed in the satellite constellation of FIG. 18;

FIG. 22 is a diagram in which a passage region is formed in the satellite constellation of FIG. 19;

FIG. 23 is a diagram of a mega-constellation according to Embodiment 2 as seen from the North Pole;

FIG. 24 is a diagram of a mega-constellation in which a passage region is formed according to Embodiment 2 as seen from the North Pole;

FIG. 25 is an example of avoidance of a collision between the mega-constellation in which the passage region is formed according to Embodiment 2 and a large-scale space object; and

FIG. 26 is a diagram illustrating an example of a configuration of an OADR according to Embodiment 3.

### DESCRIPTION OF EMBODIMENTS

Embodiments of the present disclosure will be described hereinafter with reference to the drawings. Throughout the drawings, the same or corresponding parts are denoted by the same reference signs. In the description of the embodiments, description of the same or corresponding parts will be suitably omitted or simplified. In the drawings hereinafter, the relative sizes of components may be different from actual ones. In the description of the embodiments, directions or positions such as “up”, “down”, “left”, “right”, “front”, “rear”, “top side”, and “back side” may be indicated. These terms are used only for convenience of description, and are not intended to limit the placement and orientation of components such as devices, equipment, or parts.

### Embodiment 1

*** Description of Configurations***

An example of a configuration of a satellite constellation forming system according to the following embodiments will be described.

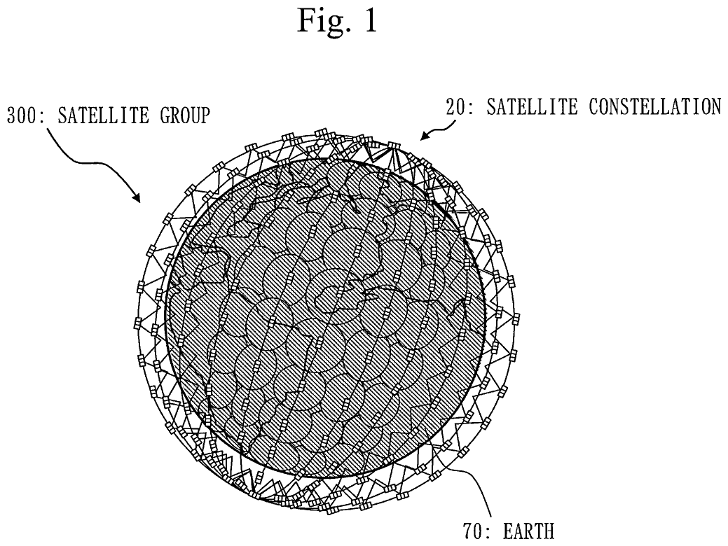

FIG. 1 is a diagram illustrating an example in which a plurality of satellites cooperatively realize a communication service to the ground over the entire globe of Earth 70.

FIG. 1 illustrates a satellite constellation 20 that realizes a communication service over the entire globe.

The ground communication service range of each satellite of a plurality of satellites flying at the same altitude in the same orbital plane overlaps the communication service range of a following satellite. Therefore, with such satellites, the satellites in the same orbital plane can provide a communication service to a specific point on the ground in turn in a time-division manner. By providing adjacent orbital planes, a communication service can be provided to the ground with widespread coverage across the adjacent orbits. Similarly, by placing a large number of orbital planes at approximately equal intervals around Earth, a communication service to the ground can be provided over the entire globe.

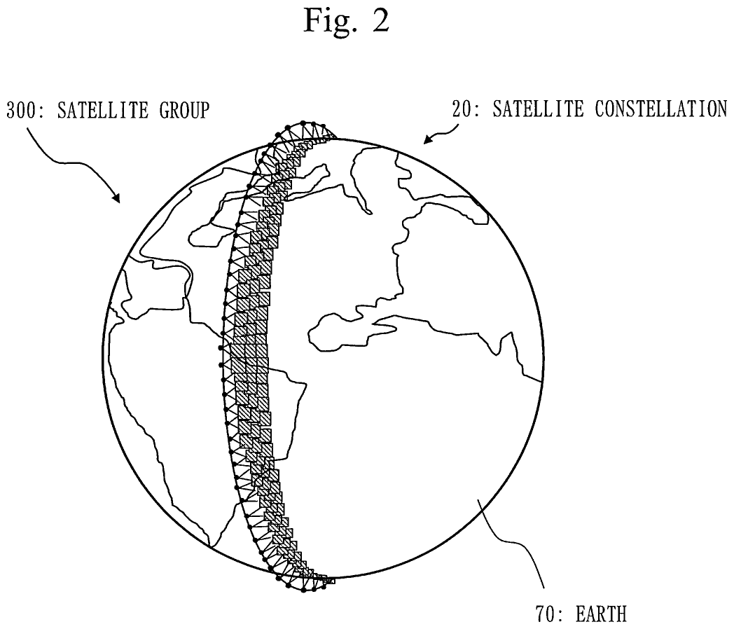

FIG. 2 is a diagram illustrating an example in which a plurality of satellites in a single orbital plane realize an Earth observation service.

FIG. 2 illustrates a satellite constellation 20 that realizes an Earth observation service. In the satellite constellation 20 of FIG. 2, satellites each equipped with an Earth observation device, which is an optical sensor or a radio sensor such as synthetic-aperture radar, fly at the same altitude in the same orbital plane. In this way, in a satellite group 300 in which the ground imaging ranges of successive satellites overlap in a time-delay manner, a plurality of satellites in orbit provide an Earth observation service by capturing ground images in turn in a time-division manner.

As described above, the satellite constellation 20 is formed with the satellite group 300 composed of a plurality of satellites in each orbital plane. In the satellite constellation 20, the satellite group 300 cooperatively provides a service. Specifically, the satellite constellation 20 refers to a satellite constellation formed with one satellite group by a communications business service company as illustrated in FIG. 1 or an observation business service company as illustrated in FIG. 2.

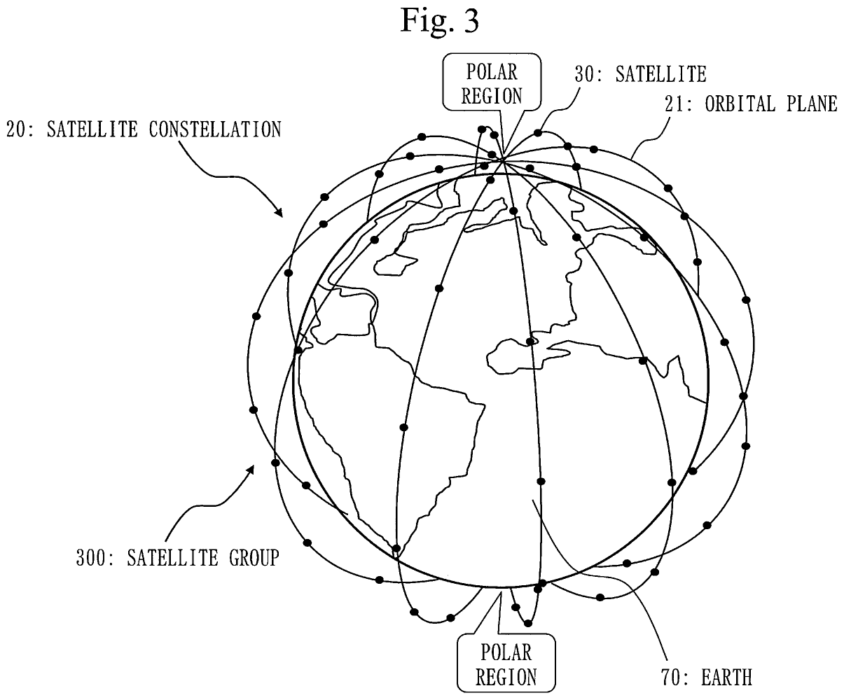

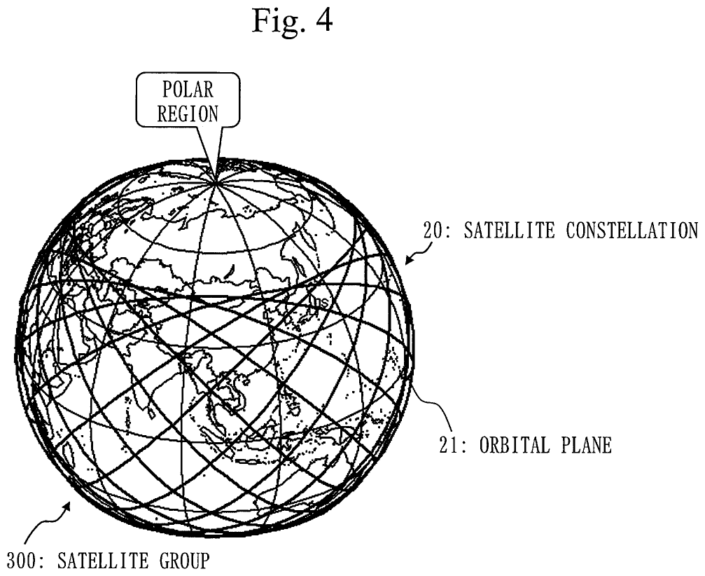

FIG. 3 is an example of a satellite constellation 20 having a plurality of orbital planes 21 that intersect in the vicinity of the polar regions. FIG. 4 is an example of a satellite constellation 20 having a plurality of orbital planes 21 that intersect outside the polar regions.

In the satellite constellation 20 of FIG. 3, the orbital inclination of each of the plurality of orbital planes 21 is about 90 degrees, and the orbital planes 21 exist on mutually different planes.

In the satellite constellation 20 of FIG. 4, the orbital inclination of each of the plurality of orbital planes 21 is not about 90 degrees, and the orbital planes 21 exist on mutually different planes.

In the satellite constellation 20 of FIG. 3, any given two orbital planes intersect at points in the vicinity of the polar regions. In the satellite constellation 20 of FIG. 4, any given two orbital planes intersect at points outside the polar regions. In FIG. 3, a collision between satellites 30 may occur in the vicinity of the polar regions. As illustrated in FIG. 4, the intersection points between the orbital planes each with an orbital inclination greater than 90 degrees move away from the polar regions according to the orbital inclination. Depending on the combinations of orbital planes, orbital planes may intersect at various locations including the vicinity of the equator. For this reason, places where collisions between satellites 30 may occur are diversified. A satellite 30 is referred to also as an artificial satellite.

In recent years, large-scale satellite constellations including several hundred to several thousand satellites have started to be constructed, and the risk of collision accidents between satellites in orbit is increasing. In addition, space debris such as an artificial satellite that has become uncontrollable due to a failure or rocket debris has been increasing. A large-scale satellite constellation is also called a mega-constellation. Such debris is also called space debris.

As described above, with the increase in debris in outer space and the rapid increase in the number of satellites such as those in a mega-constellation, the need for space traffic management (STM) is increasing.

There has been increasing need for deorbit after completion of a mission in a large-scale space object, such as the ISS, and a satellite or ADR, which causes debris such as a failed satellite or an upper stage of a rocket that is floating to deorbit by external means such as a debris removal satellite. International discussions have begun as STM on the need for such ADR. ADR is an abbreviation for Active Debris Removal.

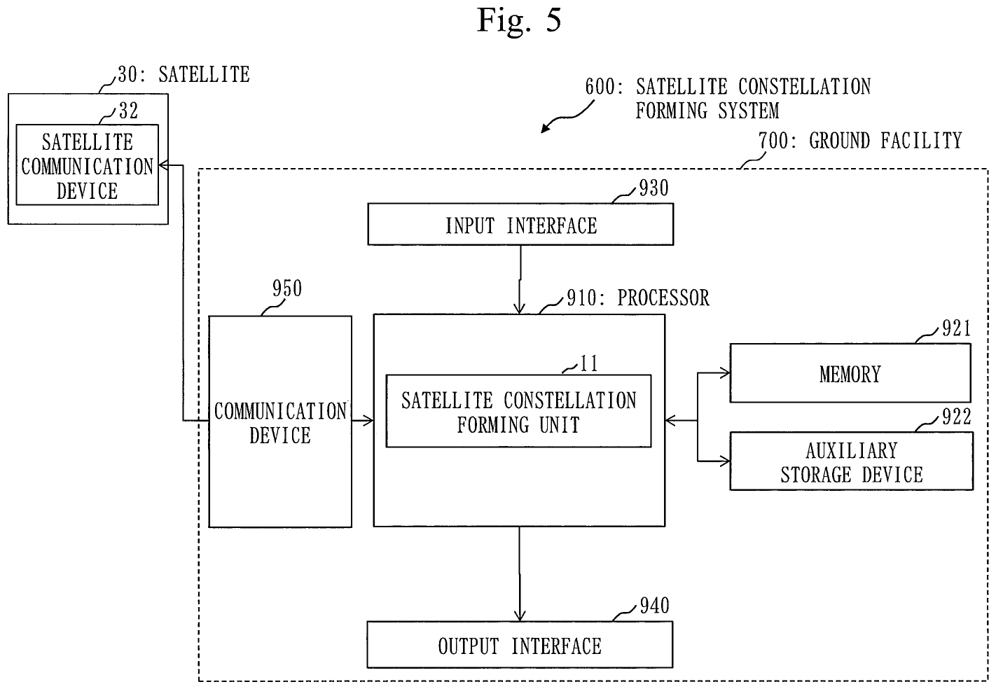

Referring to FIGS. 5 to 8, an example of a satellite constellation forming system 600 that forms a satellite constellation 20, a satellite 30 and a ground facility 700 will now be described. For example, the satellite constellation forming system 600 is operated by a business operator that conducts a satellite constellation business, such as a mega-constellation business device, a low Earth orbit (LEO) constellation business device, or a satellite business device.

A satellite control method by the satellite constellation forming system 600 is also applied to other business devices that manage space objects. Specifically, it may be installed on business devices such as a debris removal business device that manages a debris removal satellite, a rocket launch business device that launches a rocket, and an orbital transfer business device that manages an orbital transfer satellite. The satellite control method by the satellite constellation forming system 600 may be installed on any business device, provided that it is the business device of a business operator that manages a space object.

FIG. 5 is a configuration diagram of the satellite constellation forming system 600.

The satellite constellation forming system 600 includes a computer. FIG. 5 illustrates a configuration with one computer but, in practice, a computer is provided in each satellite 30 of a plurality of satellites constituting the satellite constellation 20 and the ground facility 700 that communicates with each satellite 30. The functions of the satellite constellation forming system 600 are realized cooperatively by the computers provided in each of the satellites 30 and the ground facility 700 that communicates with the satellites 30. In the following, an example of a configuration of the computer that realizes the functions of the satellite constellation forming system 600 will be described.

The satellite constellation forming system 600 includes the ground facility 700 that communicates with the satellite 30. The satellite 30 includes a satellite communication device 32 that communicates with a communication device 950 of the ground facility 700. Among the components included in the satellite 30, the satellite communication device 32 is illustrated in FIG. 5.

The satellite constellation forming system 600 includes a processor 910, and also includes other hardware components such as a memory 921, an auxiliary storage device 922, an input interface 930, an output interface 940, and a communication device 950. The processor 910 is connected with other hardware components via signal lines and controls these other hardware components.

The satellite constellation forming system 600 includes a satellite constellation forming unit 11 as a functional element. The satellite constellation forming unit 11 controls formation of the satellite constellation 20 while communicating with the satellite 30.

The functions of the satellite constellation forming unit 11 are realized by software.

The processor 910 is a device that executes a satellite constellation forming program. The satellite constellation forming program is a program that realizes the functions of the satellite constellation forming unit 11.

The processor 910 is an integrated circuit (IC) that performs operational processing. Specific examples of the processor 910 are a central processing unit (CPU), a digital signal processor (DSP), and a graphics processing unit (GPU).

The memory 921 is a storage device to temporarily store data. Specific examples of the memory 921 are a static random access memory (SRAM) and a dynamic random access memory (DRAM).

The auxiliary storage device 922 is a storage device to store data. A specific example of the auxiliary storage device 922 is an HDD. Alternatively, the auxiliary storage device 922 may be a portable recording medium, such as an SD (registered trademark) memory card, CF, a NAND flash, a flexible disk, an optical disc, a compact disc, a Blu-ray (registered trademark) disc, or a DVD. HDD is an abbreviation for Hard Disk Drive. SD (registered trademark) is an abbreviation for Secure Digital. CF is an abbreviation for CompactFlash (registered trademark). DVD is an abbreviation for Digital Versatile Disk.

The input interface 930 is a port to be connected with an input device, such as a mouse, a keyboard, or a touch panel. Specifically, the input interface 930 is a Universal Serial Bus (USB) terminal. The input interface 930 may be a port to be connected with a local area network (LAN).

The output interface 940 is a port to which a cable of a display device such as a display is to be connected. Specifically, the output interface 940 is a USB terminal or a High Definition Multimedia Interface (HDMI, registered trademark) terminal. Specifically, the display is a liquid crystal display (LCD).

The communication device 950 has a receiver and a transmitter. Specifically, the communication device 950 is a communication chip or a network interface card (NIC).

The satellite constellation forming program is read into the processor 910 and executed by the processor 910. The memory 921 stores not only the satellite constellation forming program but also an operating system (OS). The processor 910 executes the satellite constellation forming program while executing the OS. The satellite constellation forming program and the OS may be stored in the auxiliary storage device 922. The satellite constellation forming program and the OS that are stored in the auxiliary storage device 922 are loaded into the memory 921 and executed by the processor 910. Part or the entirety of the satellite constellation forming program may be embedded in the OS.

The satellite constellation forming system 600 may include a plurality of processors as an alternative to the processor 910. These processors share the execution of programs. Each of the processors is, like the processor 910, a device that executes programs.

Data, information, signal values, and variable values that are used, processed, or output by programs are stored in the memory 921 or the auxiliary storage device 922, or stored in a register or a cache memory in the processor 910.

“Unit” of each unit of the satellite constellation forming system may be interpreted as “process”, “procedure”, “means”, “phase”, or “step”. “Process” of the satellite constellation forming process may be interpreted as “program”, “program product”, or “computer readable storage medium recording a program”. The terms “process”, “procedure”, “means”, “phase”, and “step” may be interpreted interchangeably.

The satellite constellation forming program causes a computer to execute each process, each procedure, each means, each phase, or each step, where “unit” of each unit of the satellite constellation forming system is interpreted as “process”, “procedure”, “means”, “phase”, or “step”. A satellite constellation forming method is a method performed by execution of the satellite constellation forming program by the satellite constellation forming system 600.

The satellite constellation forming program may be stored and provided in a computer readable storage medium. Alternatively, each program may be provided as a program product.

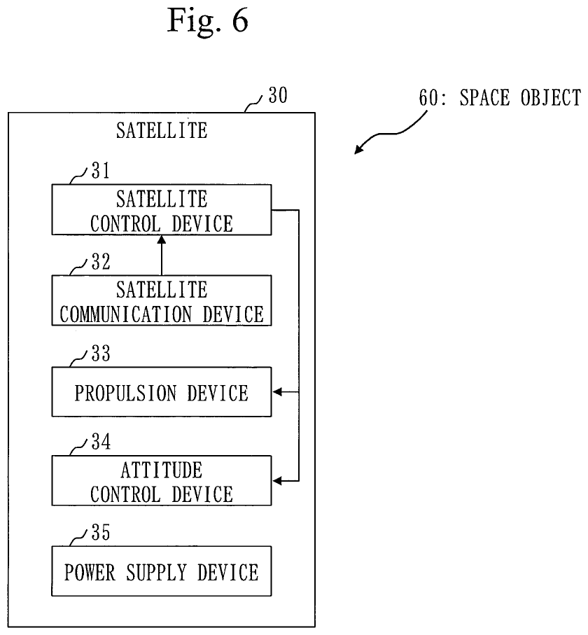

FIG. 6 is a configuration diagram of the satellite 30 of the satellite constellation forming system 600.

The satellite 30 includes a satellite control device 31, the satellite communication device 32, a propulsion device 33, an attitude control device 34, and a power supply device 35. Although other constituent elements that realize various functions are included, the satellite control device 31, the satellite communication device 32, the propulsion device 33, the attitude control device 34, and the power supply device 35 will be described in FIG. 6. The satellite 30 is an example of a space object 60.

The satellite control device 31 is a computer that controls the propulsion device 33 and the attitude control device 34 and includes a processing circuit. Specifically, the satellite control device 31 controls the propulsion device 33 and the attitude control device 34 in accordance with various commands transmitted from the ground facility 700.

The satellite communication device 32 is a device that communicates with the ground facility 700. Specifically, the satellite communication device 32 transmits various types of data related to the satellite itself to the ground facility 700. The satellite communication device 32 also receives various commands transmitted from the ground facility 700.

The propulsion device 33 is a device that provides thrust force to the satellite 30 to change the velocity of the satellite 30. Specifically, the propulsion device 33 is an apogee kick motor, a chemical propulsion device, or an electric propulsion device. The apogee keck motor (AKM) is an upper-stage propulsion device used for orbital insertion of an artificial satellite, and is also called an apogee motor (when a solid rocket motor is used) or an apogee engine (when a liquid engine is used).

The chemical propulsion device is a thruster using monopropellant or bipropellant fuel. The electric propulsion device is an ion engine or a Hall thruster. The apogee kick motor is the name of a device used for orbital transfer and may be a type of chemical propulsion device.

The attitude control device 34 is a device to control the attitude of the satellite 30 and attitude elements, such as the angular velocity and the line of sight, of the satellite 30. The attitude control device 34 changes the orientation of each attitude element to a desired orientation. Alternatively, the attitude control device 34 maintains each attitude element in a desired orientation. The attitude control device 34 includes an attitude sensor, an actuator, and a controller. The attitude sensor is a device such as a gyroscope, an Earth sensor, a sun sensor, a star tracker, a thruster, or a magnetic sensor. The actuator is a device such as an attitude control thruster, a momentum wheel, a reaction wheel, or a control moment gyroscope. The controller controls the actuator in accordance with measurement data of the attitude sensor or various commands from the ground facility 700.

The power supply device 35 includes equipment such as a solar cell, a battery, and an electric power control device, and provides electric power to each piece of equipment installed in the satellite 30.

The processing circuit included in the satellite control device 31 will be described.

The processing circuit may be dedicated hardware, or may be a processor that executes programs stored in a memory.

In the processing circuit, some functions may be realized by hardware, and the remaining functions may be realized by software or firmware. That is, the processing circuit can be realized by hardware, software, firmware, or a combination of these.

Specifically, the dedicated hardware is a single circuit, a composite circuit, a programmed processor, a parallel-programmed processor, an ASIC, an FPGA, or a combination of these.

ASIC is an abbreviation for Application Specific Integrated Circuit. FPGA is an abbreviation for Field Programmable Gate Array.

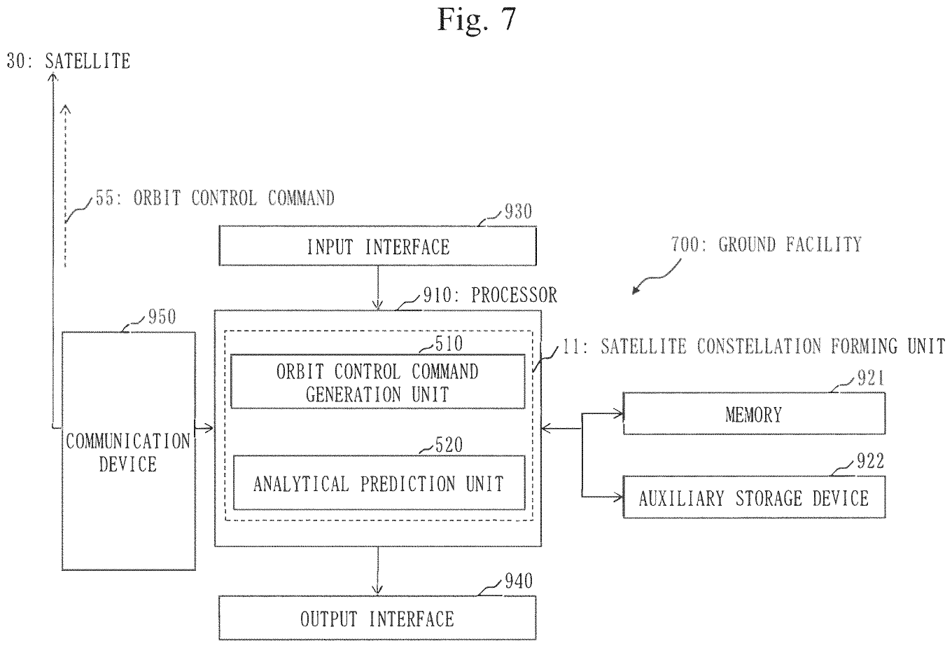

FIG. 7 is a configuration diagram of the ground facility 700 included in the satellite constellation forming system 600.

The ground facility 700 controls a large number of satellites in all orbital planes by programs. The ground facility 700 is an example of a ground device. The ground device is composed of a ground station, such as a ground antenna device, a communication device connected to a ground antenna device, or an electronic computer, and a ground facility as a server or terminal connected with the ground station via a network. The ground device may include a communication device installed in a mobile object such as an airplane, a self-driving vehicle, or a mobile terminal.

The ground facility 700 forms the satellite constellation 20 by communicating with each satellite 30. The ground facility 700 is provided in the satellite constellation forming system 600. The ground facility 700 includes a processor 910 and also includes other hardware components such as a memory 921, an auxiliary storage device 922, an input interface 930, an output interface 940, and a communication device 950. The processor 910 is connected with other hardware components via signal lines and controls these other hardware components. The hardware components of the ground facility 700 are substantially the same as the hardware components of the satellite constellation forming system 600 described with reference to FIG. 5.

The ground facility 700 includes an orbit control command generation unit 510 and an analytical prediction unit 520 as functional elements. The functions of the orbit control command generation unit 510 and the analytical prediction unit 520 are realized by hardware or software.

The communication device 950 transmits and receives signals for tracking and controlling each satellite 30 in the satellite group 300 constituting the satellite constellation 20. The communication device 950 transmits an orbit control command 55 to each satellite 30.

The analytical prediction unit 520 performs analytical prediction on the orbit of the satellite 30.

The orbit control command generation unit 510 generates an orbit control command 55 to be transmitted to the satellite 30.

The orbit control command generation unit 510 and the analytical prediction unit 520 realize the functions of the satellite constellation forming unit 11. That is, the orbit control command generation unit 510 and the analytical prediction unit 520 are examples of the satellite constellation forming unit 11.

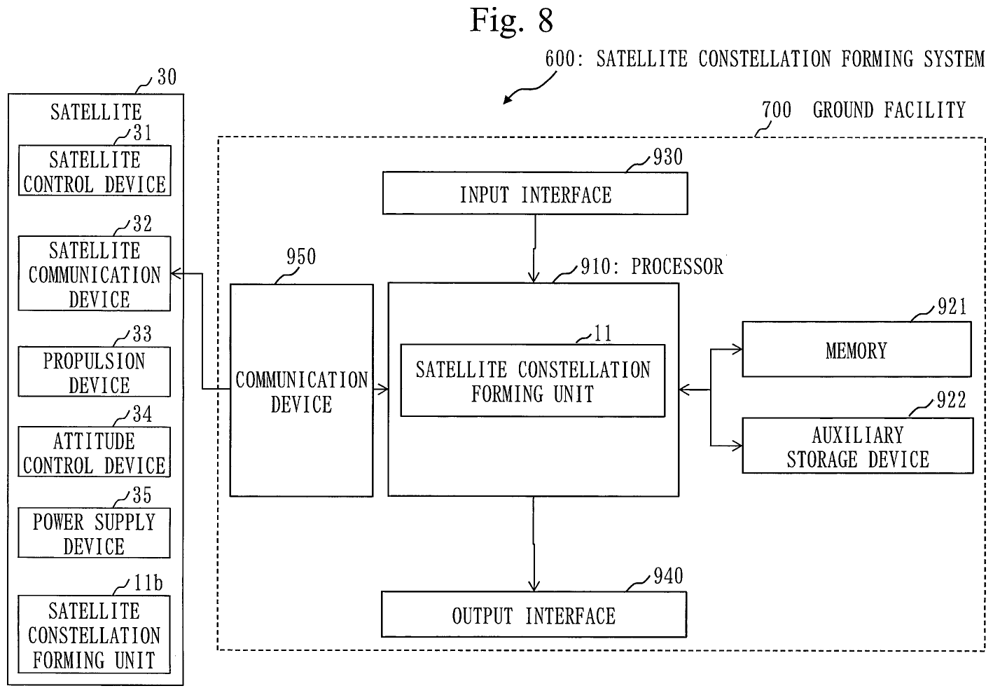

FIG. 8 is a diagram illustrating an example of a functional configuration of the satellite constellation forming system 600.

The satellite 30 further includes a satellite constellation forming unit 11b to form the satellite constellation 20. The functions of the satellite constellation forming system 600 are realized cooperatively by the satellite constellation forming unit 11b included in each satellite 30 of a plurality of satellites and the satellite constellation forming unit 11 included in the ground facility 700. The satellite constellation forming unit 11b of the satellite 30 may be included in the satellite control device 31.

*** Description of Operation ***

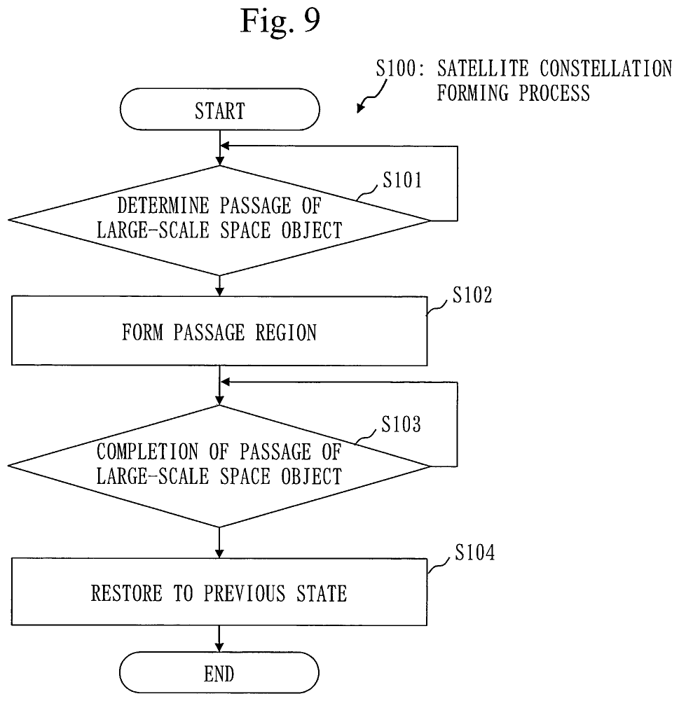

FIG. 9 is a flowchart of a satellite constellation forming process S100 by the satellite constellation forming system 600 according to this embodiment.

In this embodiment, the satellite constellation forming system 600 forms a satellite constellation having a plurality of orbital planes in each of which a plurality of satellites fly at the same average orbital altitude.

In the following description, a large-scale space object means a space object of a large scale that is about the size of the ISS, specifically.

In step S101, the satellite constellation forming unit 11 determines whether a space object will pass through an orbital altitude of the satellite constellation from above the satellite constellation. For example, it is assumed that the satellite constellation forming system 600 has formed a mega-constellation composed of a satellite group of several thousand satellites in the vicinity of an orbital altitude of 340 km. It is also assumed that the ISS is flying at an orbital altitude of about 400 km. It is expected that the ISS will deorbit for PMD after completing its mission and descend toward the mega-constellation. The satellite constellation forming unit 11 determines whether the ISS, which is a large-scale space object, will pass through an orbital altitude of the mega-constellation from above the mega-constellation.

If it is determined that a space object will pass, processing proceeds to step S102.

If it is not determined that a space object will pass, step S101 is repeated.

In step S102, the satellite constellation forming unit 11 controls a relative angle in an azimuth direction between orbital planes of the plurality of orbital planes before the space object passes through the orbital altitude of the satellite constellation from above the satellite constellation. The satellite constellation forming unit 11 forms a passage region R for the space object to pass through at the orbital altitude of the satellite constellation. The passage region R is, for example, a region where each orbital plane of the plurality of orbital planes does not exist or there are few intersection points between orbital planes. The satellite constellation forming unit 11 simultaneously changes the orbital altitudes of all the satellites in orbital planes located adjacently, and maintains a state in which the average orbital altitudes of the plurality of orbital planes arranged in the azimuth direction are raised in a sequential order. By this, the relative angle in the azimuth direction between orbital planes is narrowed and the passage region R is formed.

Specifically, the satellite constellation forming unit 11 generates an orbit control command to simultaneously change the orbital altitudes of all the satellites in orbital planes located adjacently and maintain a state in which the average orbital altitudes of the plurality of orbital planes arranged in the azimuth direction are raised in a sequential order. Then, the satellite constellation forming unit 11 transmits the orbit control command to the satellites 30 forming the satellite constellation. By performing orbit control in accordance with the orbit control command by each of the satellites forming the satellite constellation, the state in which the average orbital altitudes of the plurality of orbital planes arranged in the azimuth direction are raised in a sequential order is maintained, and the passage region R is formed.

By simultaneously changing the orbital altitudes of all the satellites in orbital planes located adjacently and maintaining the state in which the average orbital altitudes of the plurality of orbital planes arranged in the azimuth direction are raised in a sequential order, the relative angle in the azimuth direction is shifted individually for each of the orbital planes. This creates a region with a margin, that is, the passage region R among the orbital planes that have been located densely. By arranging that a large-scale space object passes through the passage region R in the process of an orbital descent in which the large-scale space object, after completing its mission, deorbits and enters the atmosphere, there is an effect that a risk of collision between the large-scale space object and the satellites constituting the satellite constellation can be reduced.

The formation of a passage region by the satellite constellation forming unit 11 will be described below using a specific example.

In this embodiment, it is assumed that the satellite constellation forming unit 11 forms a satellite constellation in which each orbital plane of a plurality of orbital planes passes through the polar regions and the polar regions are regions congested with the orbital planes. That is, it is the satellite constellation 20 described with reference to FIGS. 1 and 3. An example will be described here in which the satellite constellation forming unit 11 forms a region resulting from enlarging a space between orbital planes through which a space object is to pass among the plurality of orbital planes as the passage region R.

FIGS. 10 to 12 are diagrams illustrating the satellite constellation 20 according to this embodiment.

FIGS. 10 to 12 illustrate an example of the satellite constellation 20 composed of polar orbit satellites with an orbital inclination of about 90 degrees. In the satellite constellation 20 of FIGS. 10 to 12, the congested region is in the vicinity of each of the polar regions.

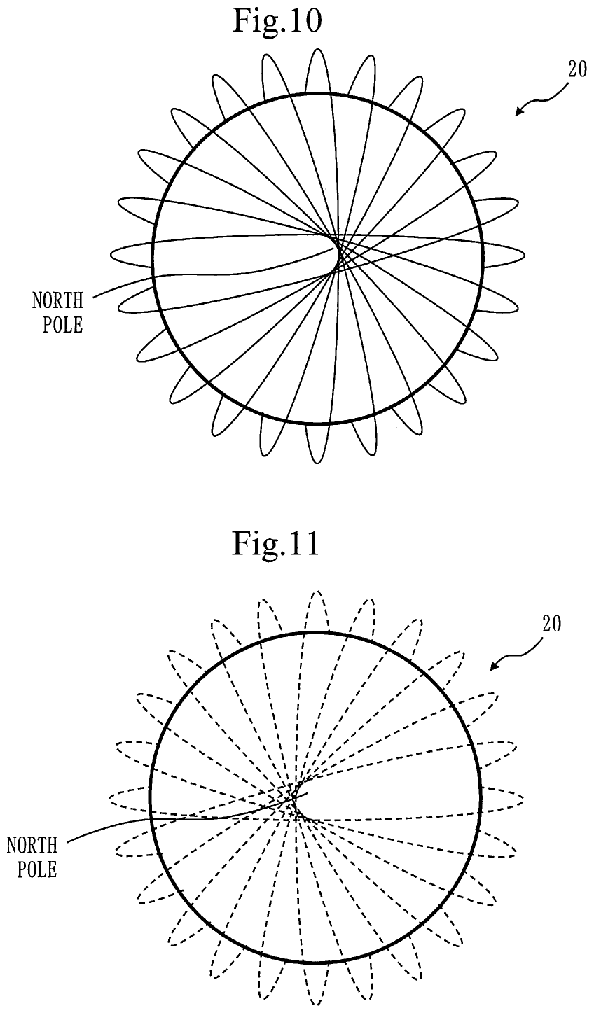

FIG. 10 is a diagram of 12 orbital planes of the satellite constellation 20 composed of 24 orbital planes according to this embodiment as seen from a direction of the North Pole. FIG. 11 illustrates 12 orbital planes other than the 12 orbital planes of FIG. 10. FIG. 12 illustrates a total of 24 orbital planes resulting from combining the 12 orbital planes of FIG. 10 and the 12 orbital planes of FIG. 11.

The azimuth components of the normal lines of the orbital planes are separated each by 15 degrees. However, when seen from the North Pole, two orbital planes in which the azimuth components of the normal lines are directed to face each other appear to be overlapping. Therefore, it is necessary to note that it is easy to get an illusion that there are 12 orbital planes in FIG. 12.

FIGS. 13 to 15 are diagrams illustrating the satellite constellation 20 in which the passage region R is formed according to this embodiment.

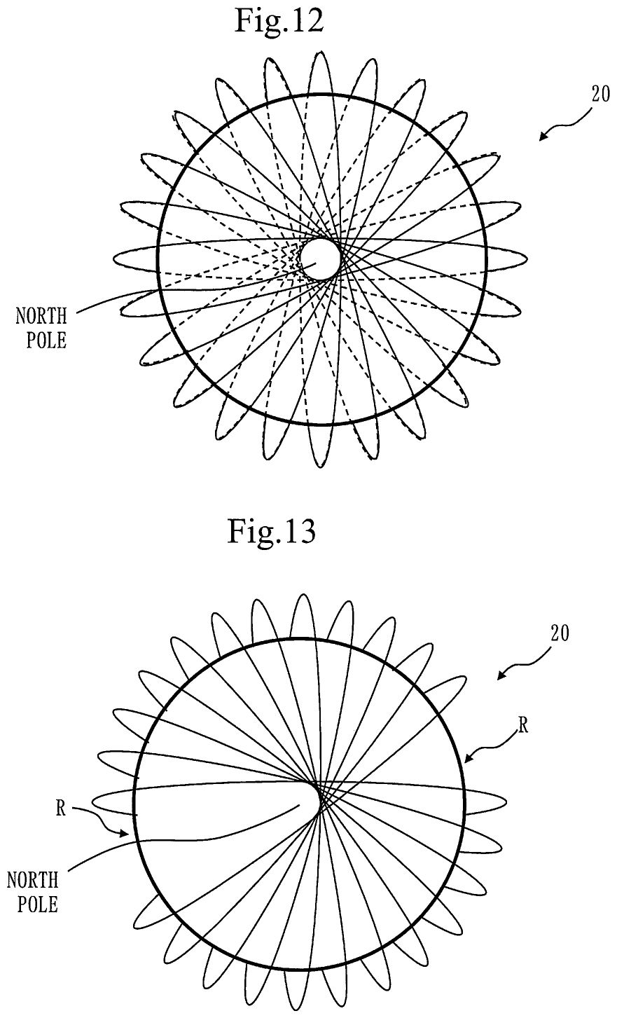

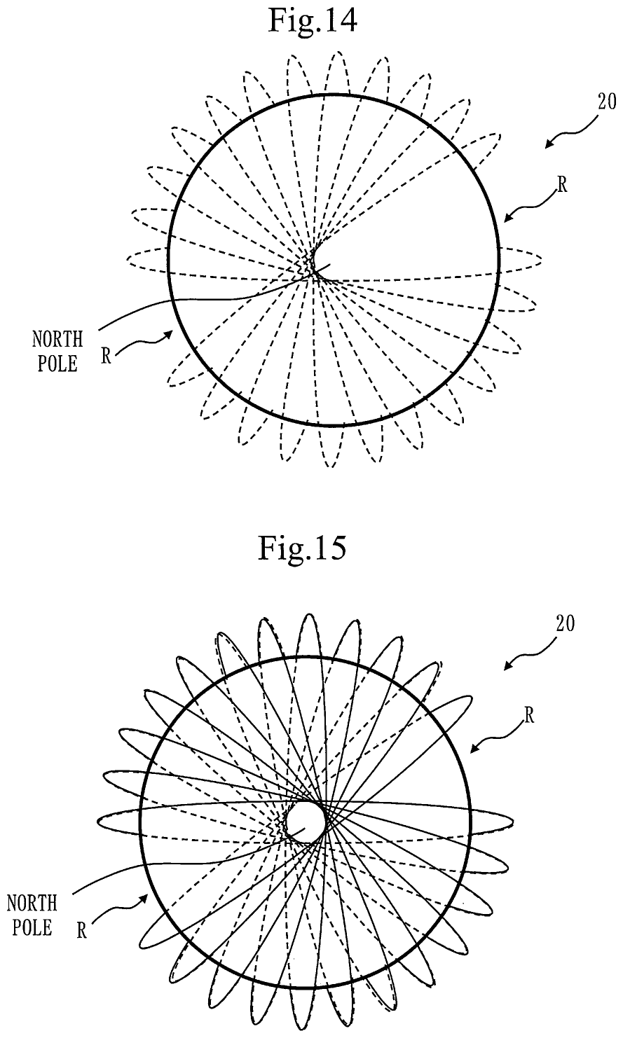

FIG. 13 is a diagram in which the passage region R is formed in the satellite constellation 20 of FIG. 10. FIG. 14 is a diagram in which the passage region R is formed in the satellite constellation 20 of FIG. 11. FIG. 15 is a diagram in which the passage region R is formed in the satellite constellation 20 of FIG. 12.

The satellite constellation forming unit 11 simultaneously changes the orbital altitudes of all the satellites in orbital planes located adjacently, and maintains the state in which the average orbital altitudes of the plurality of orbital planes arranged in the azimuth direction are raised in a sequential order. By this, the relative angle in the azimuth direction between orbital planes is narrowed and the passage region R is formed in part of the orbital altitudes of the satellite constellation 20.

The orbital planes of FIGS. 13 and 14 are obtained by shifting the azimuth components of orbital planes located adjacently each by two degrees in the orbital planes of FIGS. 10 and 11. FIG. 15 illustrates the 24 orbital planes resulting from overlapping FIGS. 13 and 14. As a result, it can be seen that a gap, that is, the passage region R is generated between the orbital planes. As illustrated in FIG. 15, the passage region R is a region with a margin where no orbital plane is located or there are few orbital planes. If a large-scale space object passes through the passage region R like this, the large-scale space object can descend without a risk of colliding with the satellites forming the satellite constellation 20.

In step S103, the satellite constellation forming unit 11 determines whether the space object has passed through the passage region.

If it is determined that the passage of the space object has completed, processing proceeds to step S104.

If it is not determined that the passage of the space object has completed, step S103 is repeated.

In step S104, after the space object has passed through the passage region R, the satellite constellation forming unit 11 restores the relative angle in the azimuth direction between orbital plane in the plurality of orbital planes. As a result, the satellite constellation 20 is restored to the state before the passage region R is formed. The satellite constellation forming unit 11 maintains a state in which the average orbital altitudes of the plurality of orbital planes arranged in the azimuth direction are lowered in a sequential order. As a result, the relative angle in the azimuth direction between orbital planes of the plurality of orbital planes is restored, and the satellite constellation 20 is restored to the state before the passage region R is formed.

Specifically, the satellite constellation forming unit 11 generates an orbit control command to simultaneously change the orbital altitudes of all the satellites in orbital planes located adjacently and maintain the state in which the average orbital altitudes of the plurality of orbital planes arranged in the azimuth direction are lowered in a sequential order. Then, the satellite constellation forming unit 11 transmits the orbit control command to the satellites forming the satellite constellation. By performing orbit control in accordance with the orbit control command by each of the satellites forming the satellite constellation, the state in which the average orbital altitudes of the plurality of orbital planes arranged in the azimuth direction are lowered in a sequential order is maintained, and the satellite constellation 20 is restored to the state before the passage region R is formed.

By step S104, the satellite constellation 20 is restored from the state of FIGS. 13 to 15 in which the passage region R is formed to the state of FIGS. 10 to 12 in which the passage region R is not formed.

*** Other Configurations ***

In this embodiment, the functions of the satellite constellation forming system 600 are realized by software. As a variation, the functions of the satellite constellation forming system 600 may be realized by hardware.

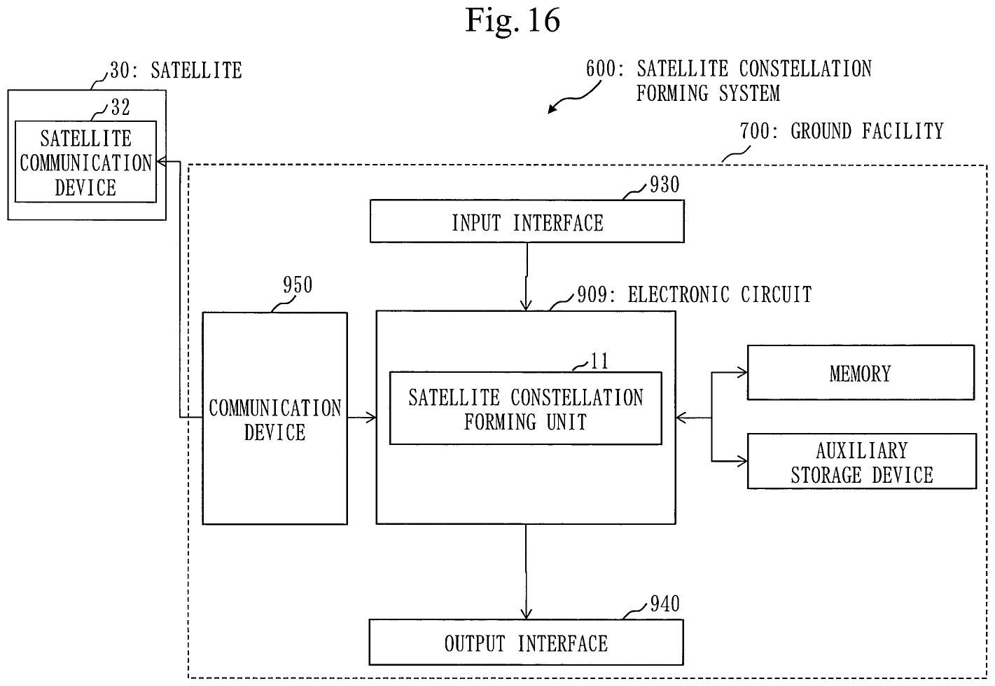

FIG. 16 is a diagram illustrating a configuration of the satellite constellation forming system 600 according to a variation of this embodiment.

The satellite constellation forming system 600 includes an electronic circuit 909 in place of the processor 910.

The electronic circuit 909 is a dedicated electronic circuit that realizes the functions of the satellite constellation forming system 600.

Specifically, the electronic circuit 909 is a single circuit, a composite circuit, a programmed processor, a parallel-programmed processor, a logic IC, a GA, an ASIC, or an FPGA. GA is an abbreviation for Gate Array.

The functions of the satellite constellation forming system 600 may be realized by one electronic circuit, or may be distributed among and realized by a plurality of electronic circuits.

As another variation, some of the functions of the satellite constellation forming system 600 may be realized by the electronic circuit, and the rest of the functions may be realized by software.

Each of the processor and the electronic circuit is also called processing circuitry. That is, the functions of the satellite constellation forming system 600 are realized by the processing circuitry.

*** Description of Effects of This Embodiment ***

When a large-scale space object such as the ISS passes through an orbital altitude at which a mega-constellation is present, it is rational to avoid a collision by arranging that the mega-constellation enlarges an area through which passage can be made.

The satellite constellation forming system according to this embodiment changes the angles in the azimuth direction between adjacent orbital planes, which are normally maintained at equal intervals. By this change, it is possible to secure a region with a large margin, that is, a passage region between orbital planes.

Therefore, with the satellite constellation forming system according to this embodiment, when a large-scale space object like the ISS deorbits, a collision between a satellite and the ISS can be avoided. In addition, with the satellite constellation forming system according to this embodiment, there is an effect that a collision can be avoided also in a rocket launch and an orbital transfer of a transfer satellite from the perigee to the apogee.

### Embodiment 2

In this embodiment, differences from Embodiment 1 or additions to Embodiment 1 will be mainly described. In this embodiment, components that are substantially the same as those in Embodiment 1 will be denoted by the same reference signs and description thereof will be omitted.

The configurations of the satellite constellation forming system 600, the satellite 30, and the ground facility 700 according to this embodiment are substantially the same as those in Embodiment 1.

In this embodiment, it is assumed that the satellite constellation forming unit 11 forms a satellite constellation in which each orbital plane of a plurality of orbital planes does not pass through the polar regions and a mid-latitude region is a region congested with the orbital planes. That is, it is the satellite constellation 20 described with reference to FIG. 4. Specifically, the mid-latitude region is each of the vicinity of a latitude of 50 degrees north and the vicinity of a latitude of 50 degrees south. The satellite constellation forming unit 11 forms a region in which the density of orbital planes is alleviated as the passage region R.

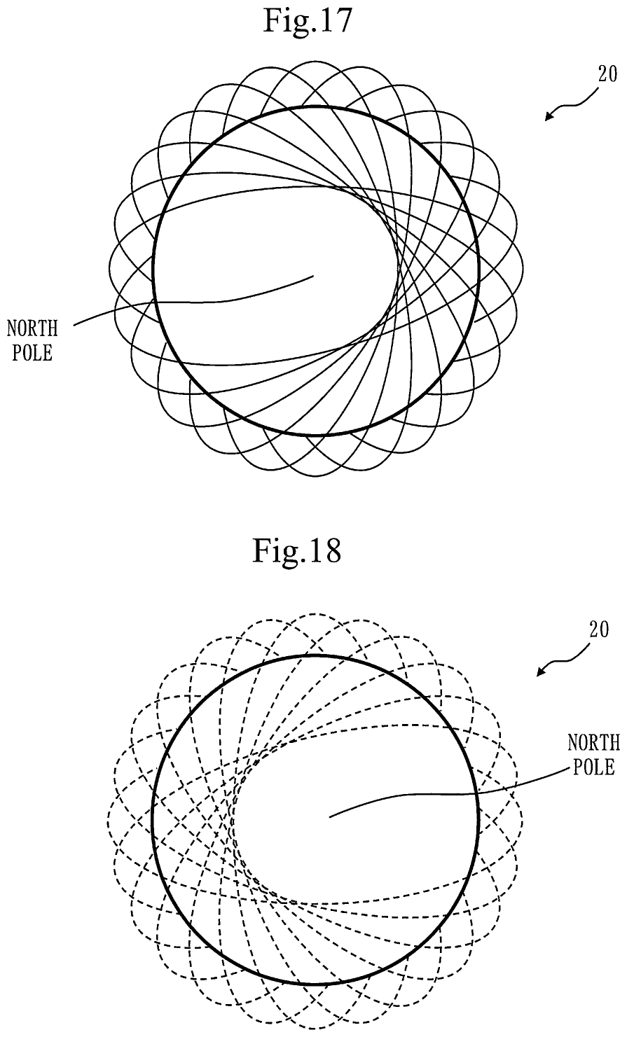

FIG. 17 is a diagram of 12 orbital planes of the satellite constellation 20 composed of 24 orbital planes according to this embodiment as seen from the direction of the North Pole. FIG. 18 illustrates 12 orbital planes other than the 12 orbital planes of FIG. 17. FIG. 19 illustrates a total of 24 orbital planes resulting from combining the 12 orbital planes of FIG. 17 and the 12 orbital planes of FIG. 18.

FIGS. 17 to 19 illustrate an example of the satellite constellation 20 composed of satellites in orbit with an orbital inclination away from 90 degrees. In the satellite constellation 20 of FIGS. 17 to 19, the congested region is in the vicinity of the mid-latitude region.

Each of FIGS. 17 and 18 illustrates 12 orbital planes as seen from the North Pole, as in the case of FIGS. 10 and 11. FIG. 19 illustrates 24 orbital planes resulting from combining the 12 orbital planes of each of FIG. 17 and FIG. 18. In FIG. 12 of Embodiment 1, there is a region congested with all the orbital planes in the polar region. In FIG. 19 of this embodiment, the latitude of the congested region, which has been in the polar region, is lowered to mid-latitude, and the degree of congestion is also alleviated. On the other hand, intersection points between orbital planes exist in a grid pattern over the entire mid-latitude region.

In a mega-constellation, several tens of satellites are flying in each orbital plane. Therefore, an overlap or an intersection point of orbital planes indicates a possibility of collision. Accordingly, an area with a high degree of congestion indicates a high probability of collision.

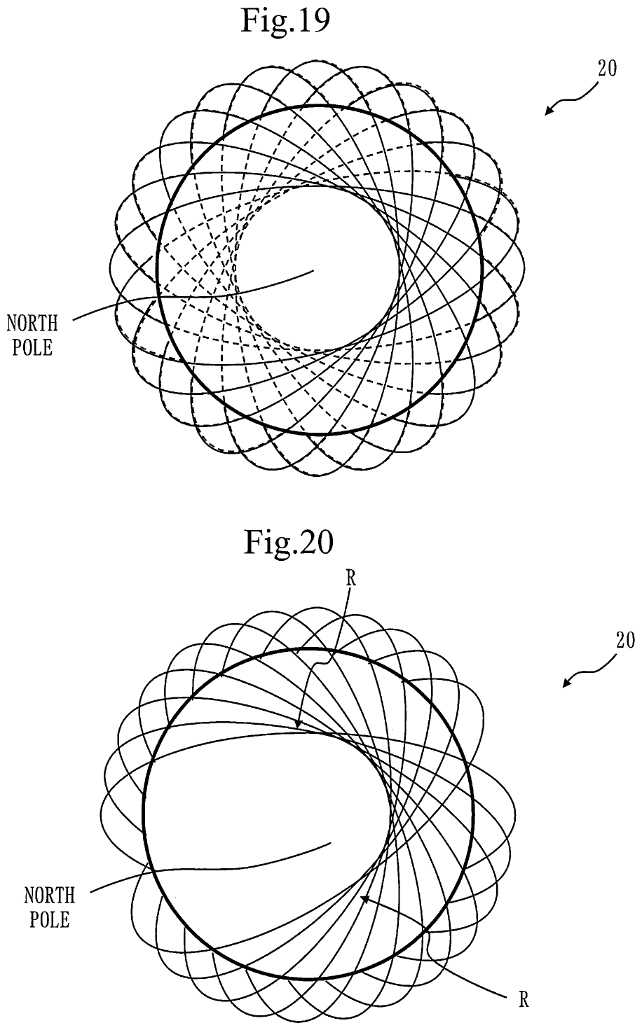

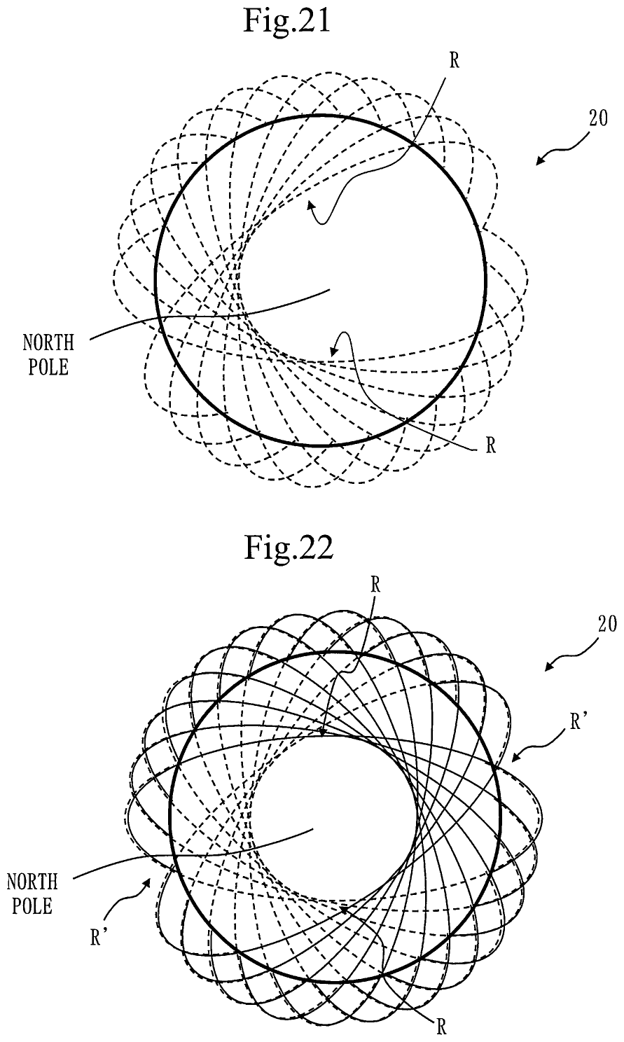

FIG. 20 is a diagram in which the passage region R is formed in the satellite constellation 20 of FIG. 17. FIG. 21 is a diagram in which the passage region R is formed in the satellite constellation 20 of FIG. 18. FIG. 22 is a diagram in which the passage region R is formed in the satellite constellation 20 of FIG. 19.

The satellite constellation forming unit 11 simultaneously changes the orbital altitudes of all the satellites in orbital planes located adjacently, and maintains the state in which the average orbital altitudes of the plurality of orbital planes arranged in the azimuth direction are raised in a sequential order. By this, the relative angle in the azimuth direction between orbital planes is narrowed and the passage region R is formed. The passage region R here is a region in which the degree of congestion of overlaps or intersection points of orbital planes is alleviated.

By shifting the azimuth components of orbital planes located adjacently each by two degrees in the orbital planes of FIGS. 17 and 18, the orbital planes of FIGS. 20 and 21 are obtained. FIG. 22 illustrates the 24 orbital planes resulting from overlapping the orbital planes of FIG. 20 and the orbital planes of FIG. 21. As a result, it can be seen that a region with a margin where the degree of congestion of overlaps or intersection points of orbital planes is alleviated, that is, the passage region R is generated in the mid-latitude region. The orbital inclination of the ISS is away from 90 degrees and is close to the orbital inclination of the mega-constellation planned to be built at an orbital altitude of 340 km. Therefore, this passage region R is more effective for an effect of the ISS. As illustrated in FIG. 22, unlike polar orbit satellites, there are intersection points of orbital planes with the azimuth components of the normal lines facing each other in the mid-latitude zone in the passage region R. However, when FIG. 19 and FIG. 22 are compared, it can be seen that a risk of collision is reduced by forming the passage region R.

Also in this embodiment, after the space object has passed through the passage region R, the satellite constellation forming unit 11 restores the satellite constellation 20 to the state before the passage region R is formed. The satellite constellation 20 is restored from the state of FIGS. 20 to 22 in which the passage region R is formed to the state of FIGS. 17 to 19 in which the passage region R is not formed.

A specific example in which the ISS deorbits and makes an orbital descent will now be described.

The ISS is flying with an orbital inclination of about 50 degrees and at an orbital altitude of about 400 km. In the process of deorbiting and making an orbital descent, the ISS descends in orbital altitude while roughly maintaining an orbital inclination of about 50 degrees. In deorbiting and making an orbital descent, the ISS needs to change the orbital altitude without colliding with a mega-constellation planned to be built as follows:

about 2500 satellites with an orbital inclination of about 53 degrees and at an orbital altitude of about 346 km,

about 2500 satellites with an orbital inclination of about 48 degrees and at an orbital altitude of about 341 km, and

about 2500 satellites with an orbital inclination of about 42 degrees and at an orbital altitude of about 336 km.

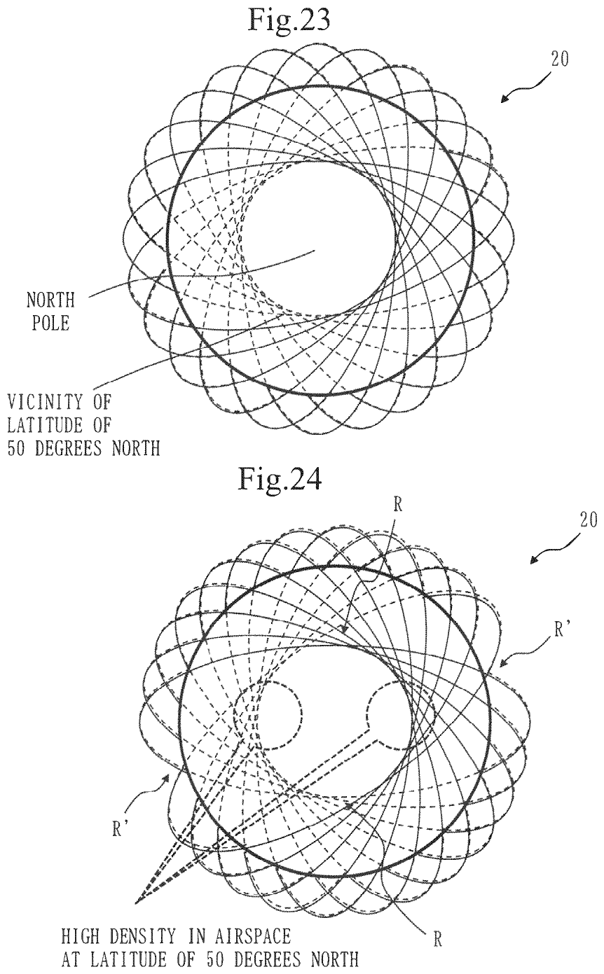

FIG. 23 is a diagram of the mega-constellation according to this embodiment as seen from the North Pole.

As indicated in FIG. 23, the northernmost ends and southernmost ends of all the orbital planes are located in the vicinity of a latitude of about 50 degrees north and the vicinity of a latitude of about 50 degrees south, respectively. Therefore, in the vicinity of a latitude of about 50 degrees north and the vicinity of a latitude of about 50 degrees south, the residence time for satellites to fly in an east-west direction is long, and intersection points of orbital planes exist densely. The vicinity of a latitude of about 50 degrees north and the vicinity of a latitude of about 50 degrees south are dangerous zones with an extremely high risk of collision.

FIG. 24 is a diagram of the mega-constellation in which the passage region R is formed according to this embodiment as seen from the North Pole.

As illustrated in FIG. 24, the satellite constellation forming system 600 according to this embodiment generates a region where the density of intersection points of orbital planes is high and a region where the density of intersection points of orbital planes is alleviated at a latitude of about 50 degrees north. This has the effect of alleviating the density of the high-density dangerous zones of the northernmost and southernmost ends of the orbital planes, so that this non-dense region is used as the passage region R for a large-scale space object so as to avoid a collision. The orbit of a large-scale space object, such as the ISS, can be grasped in advance, so that the mega-constellation may shift the orbital planes according to the angle in the azimuth direction of the orbital planes in a time period when the orbital altitude is in the vicinity of 340 km.

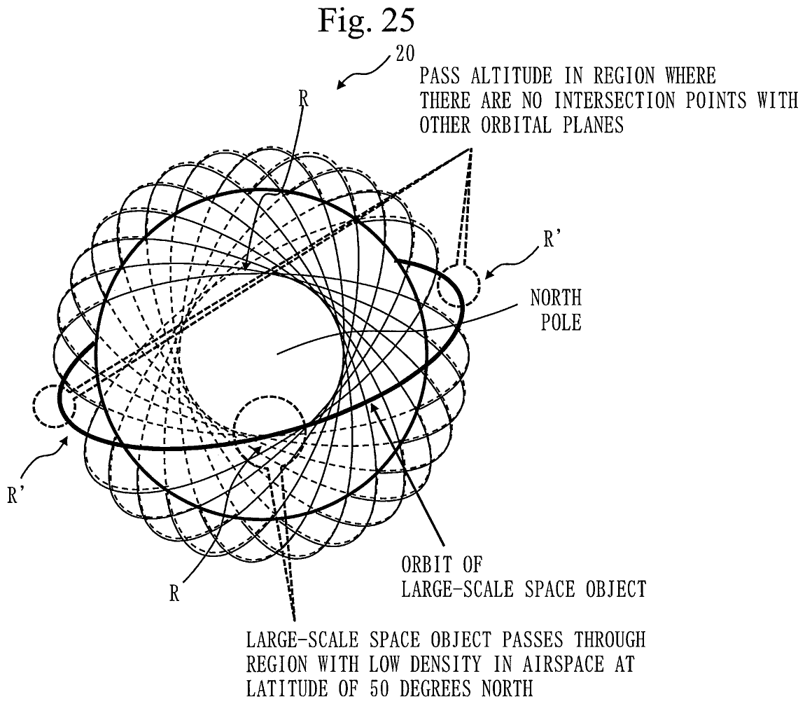

FIG. 25 is a diagram illustrating an example of avoidance of a collision between the mega-constellation in which the passage region R is formed according to this embodiment and a large-scale space object.

Although the high density is alleviated, the vicinity of each of the northernmost end and the southernmost end of each of the orbital planes is still a dangerous zone where intersection points with other orbital planes exist densely. Therefore, it is desirable that the passage through the dangerous altitude zone is performed through a passage region R′ which is above the equator and in which there is no intersection point of orbital planes. When a propulsion device to be used for deorbit has very large thrust, it is effective for the large-scale space object to decelerate rapidly above the equator and pass through the dangerous altitude zone in a short time.

When it is not possible to provide a propulsion device with such high thrust, a realistic collision avoidance measure is to shift the time period in which the large-scale space object passes by the satellites so as to avoid a collision in the region where there are intersection points of orbital planes.

Since the vicinity of each of the northernmost end and the southernmost end of the orbital planes is the dangerous zone, it is effective to pass through dangerous altitude zones, which are, for example, altitude zones of an orbital altitude of about 346 km, an orbital altitude of about 341 km, and an orbital altitude of about 336 km, within a period from passage through the polar region to next passage through the polar region.

The term “altitude zone” is used because the orbital altitude of the satellite group composed of about 2500 satellites at each altitude varies or fluctuates.

In Embodiments 1 and 2, the following business devices have been described.

A business device of a business operator that manages a satellite constellation includes the satellite constellation forming system or the ground facility described in the above embodiments. The business device of the business operator that manages a satellite constellation executes the satellite constellation forming method or the satellite constellation forming program described in the above embodiments. The business device of the business operator that manages a satellite constellation is also referred to as the business device of a satellite constellation.

A business device of a business operator that manages a space object causes the business device of the business operator that manages a satellite constellation to execute the satellite constellation forming method or the satellite constellation forming program described in the above embodiments. The business device of the business operator that manages a space object is also referred to as the business device of a space object.

A typical example of a large-scale space object is the International Space Station (ISS). As the business operator that manages a space object, business operators such as NASA that presides over management of the ISS, JAXA that manages the Japanese Experiment Module (JEM) “Kibo”, and ESA that manages the European module may be pointed out. NASA is an abbreviation for National Aeronautics and Space. JAXA is an abbreviation for Japan Aerospace Exploration Agency. ESA is an abbreviation for European Space Agency.

The ISS flying at an orbital altitude of about 400 km deorbits and makes an orbital descent after completing its mission. At this time, it is necessary to enter the atmosphere by passing through an orbital altitude at which a mega-constellation satellite group planned to be built at an orbital altitude of about 340 km fly, for example. At an orbital altitude of about 340 km, the influence of atmospheric drag cannot be ignored. A large-scale space object, such as the ISS, is equipped with a structure that has a large area and is easily affected by the influence of atmospheric drag, such as a large-scale solar array wing. With such a large-scale space object, a problem is that a prediction error is large even if a predicted orbit in an orbital descent is analyzed, and there is a high risk of collision with the mega-constellation satellite group.

It is also expected that orbit control of individual satellites is performed from moment to moment in the mega-constellation satellite group so as to prevent a collision within its own system. Therefore, another problem is that it is difficult for the business operator that manages the large-scale space object to grasp real-time high-precision orbit information of the mega-constellation satellite group in advance.

Thus, it is rational that the business operator that manages the ISS, the JEM, the European module, or the like causes the mega-constellation business operator to secure flight safety by the satellite constellation forming method described in the above embodiments so as to achieve passage through orbital altitudes.

The ISS is a large-scale space object jointly managed by multiple countries or multiple institutions. Therefore, it is unclear whether, in an orbital descent of the ISS, the orbital descent is made in a complete state in which the modules managed by the multiple countries remain being coupled or the orbital descent is made after disassembling the modules. Even when the orbital descent is made in the coupled state, the business device of each of the business operators involved is applied as the business device of the space object described above.

The business device includes a terminal connected by a network such as a communication line or an Internet line, regardless of whether it is wired or wireless.

### Embodiment 3

In this embodiment, differences from Embodiments 1 and 2 or additions to Embodiments 1 and 2 will be mainly described. In this embodiment, components that are substantially the same as those in Embodiments 1 and 2 will be denoted by the same reference signs and description thereof will be omitted.

In this embodiment, an open architecture data repository that discloses orbit information of a space object will be described. In the following, the open architecture data repository may be referred to as an OADR 800. The OADR is an abbreviation for Open Architecture Data Repository.

A specific example of the OADR 800 will be described below.

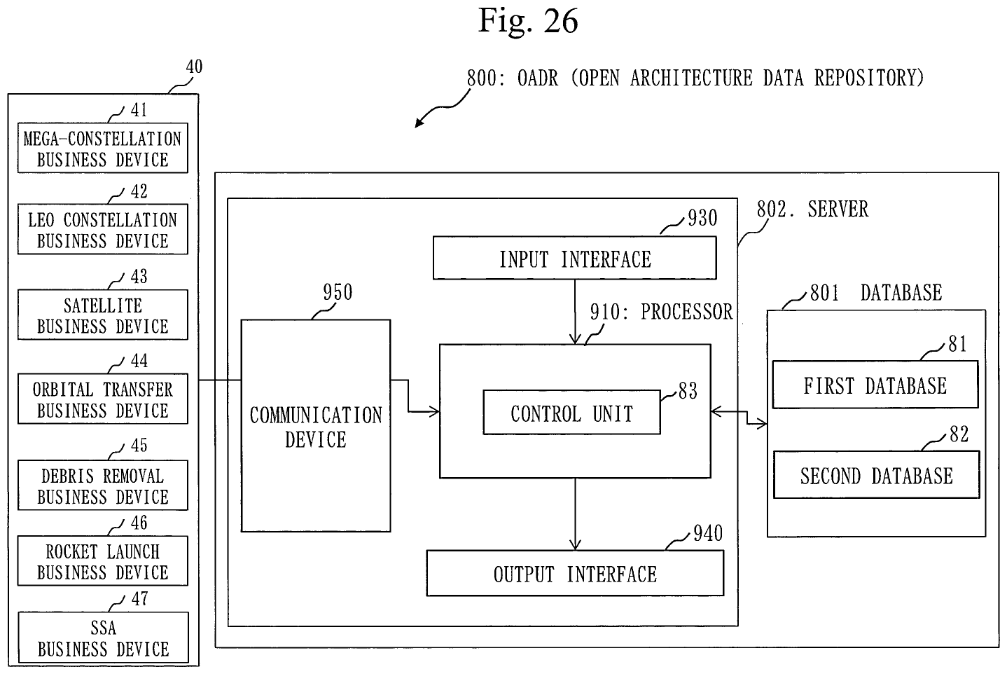

FIG. 26 is a diagram illustrating an example of a configuration of the OADR 800 according to this embodiment.

The OADR 800 includes a database 801 to store orbit information of a space object and a server 802.

The database 801 includes a first database 81 to store non-public information and a second database 82 to store public information.

The server 802 causes the business operator that manages the satellite constellation described above to execute the satellite constellation forming method or the satellite constellation forming program described above, based on orbit information of a space object acquired from the business device of the business operator that manages the space object, a debris removal business device, or an SSA business device.

Specifically, the server 802 includes a control unit 83 as a functional element, and the functions of the server 802 are realized by the control unit 83.

A business device 40 (also called a management business device) in FIG. 26 provides information related to space objects 60 such as artificial satellites or debris. The business device 40 is a computer of a business operator that collects information related to the space objects 60 such as artificial satellites or debris.

The business device 40 includes devices such as a mega-constellation business device 41, an LEO constellation business device 42, a satellite business device 43, an orbital transfer business device 44, a debris removal business device 45, a rocket launch business device 46, and an SSA business device 47. SSA is an abbreviation for Space Situational Awareness. LEO is an abbreviation for Low Earth Orbit.

The mega-constellation business device 41 is a computer of a mega-constellation business operator that conducts a large-scale constellation, that is, mega-constellation business. The mega-constellation business device 41 is, for example, a business device that manages a satellite constellation composed of 100 or more satellites.

The LEO constellation business device 42 is a computer of an LEO constellation business operator that conducts a low Earth orbit constellation, that is, LEO constellation business.

The satellite business device 43 is a computer of a satellite business operator that handles one to several satellites.

The orbital transfer business device 44 is a computer of an orbital transfer business operator that performs a space object intrusion alert for a satellite.

The debris removal business device 45 is a computer of a debris removal business operator that conducts a debris retrieval business.

The rocket launch business device 46 is a computer of a rocket launch business operator that conducts a rocket launch business.

The SSA business device 47 is a computer of an SSA business operator that conducts an SSA business, that is, a space situation awareness business. The SSA business operator publishes at least part of space object information collected by the SSA business on the server, for example.

The business device 40 may be a device other than the above, provided that it is the device that collects information on space objects such as artificial satellites or debris, and provides the collected information to a space traffic management system 500.

There may be a case in which the OADR has an authority to instruct or request a satellite constellation business operator to take a collision avoidance action. A large-scale space object such as the International Space Station, a large-scale satellite, or an upper stage of a rocket may, in the process of deorbiting, pass through the altitude zone in which a large-scale satellite constellation is flying. There is an effect that collision avoidance can be conducted rationally by arranging that the OADR causes the satellite constellation forming method or the satellite constellation forming program described above to be executed when such passage is foreseen.

The functions and effects of the OADR 800 according to this embodiment will be described further below.

Consideration is being given to securing flight safety for space objects by constructing a public information system called an OADR so as to share information among business operators.

When the OADR is constructed as a public institution for international cooperation, an authority for issuing an instruction or a request across a national border may be given to a business operator.

For example, to centrally manage orbit information of space objects held by business operators around the world, it is rational if an instruction or request to provide orbit information to the OADR can be made under rules based on an international consensus.

When a particular country constructs the OADR as a public institution, an authority to issue an instruction or request may be given to a business operator in the country concerned.

It may be arranged such that information is disclosed unconditionally to business operators of the country concerned and information is disclosed conditionally to other business operators.

The following can be set as disclosure conditions: a payment requirement, a fee setting, a restriction of disclosed items, a restriction of precision of disclosed information, a restriction of disclosure frequency, non-disclosure to a specific business operator, and so on.

For example, a difference between free and chargeable or a difference in fee for acquiring information may arise between the country concerned and other countries, and the setting of disclosure conditions by the OADR creates a system of space traffic management and has influence in terms of industrial competitiveness.

It is rational that confidential information on space objects that contributes to security is held by the OADR constructed as a public institution by a nation and is not disclosed to third parties. For this reason, the OADR may include a database to store non-public information in addition to a database for the purpose of information disclosure.

Space object information held by a private business operator includes information that cannot be disclosed generally due to corporate secrets or information that is not appropriate to be disclosed in the light of the amount of information or update frequency due to constant maneuver control.

When danger analysis and analytical evaluation related to proximity and collisions between space objects are to be performed, it is necessary to take into account orbit information of all space objects regardless of whether or not space objects require confidentiality.

For this reason, it is rational that the OADR as a public institution carries out danger analysis taking confidential information into account, and as a result of analytical evaluation, discloses information conditionally as described below. For example, when danger is foreseen, the OADR processes information to allow disclosure and then discloses information by restricting a disclosure recipient or disclosure content, such as disclosing only orbit information of a time period for which the danger is foreseen to a disclosure recipient that will contribute to avoiding the danger.

If the number of objects in orbit increases and the risk of proximity and collision increases in the future, various danger avoidance measures will be necessary, such as a measure in which a debris removal business operator removes dangerous debris and a measure in which a mega-constellation business operator changes an orbital location or passage timing to avoid a collision. If the OADR that is a public institution can instruct or request a business operator to execute a danger avoidance action, a significant effect can be expected in securing flight safety in space.

In such a case in which it is foreseen that a space object managed by an emerging country, a venture business operator, or a university that has little experience in space business and lacks information that contributes to danger avoidance will intrude into an orbital altitude zone in which a mega-constellation flies, danger avoidance can be effected promptly and effectively by the OADR acting as an intermediary to transmit information to business operators as required.

By executing a danger avoidance measure and arranging or introducing space insurance for a private business operator, contribution can be made to the promotion and industrialization of space traffic management.

Arrangements for realizing the OADR include an arrangement in which only a public database is included and an arrangement in which danger analysis means, collision avoidance assistance means, or SSA means is provided to independently contribute to danger avoidance. There are also various possibilities, such as an arrangement that contributes to danger avoidance by information management through instructing, requesting, acting as an intermediary for, or making introductions to business operators.

In Embodiments 1 to 3 above, each unit of the satellite constellation forming system has been described as an independent functional block. However, the configuration of the satellite constellation forming system may be different from the configurations described in the above embodiments. The functional blocks of the satellite constellation forming system may be arranged in any configuration, provided that the functions described in the above embodiments can be realized. The satellite constellation forming system may a single device or a system composed of a plurality of devices.

Portions of Embodiments 1 to 3 may be implemented in combination. Alternatively, one portion of these embodiments may be implemented. These embodiments may be implemented as a whole or partially in any combination.

That is, in Embodiments 1 to 3, portions of Embodiments 1 to 3 may be freely combined, or any constituent element may be modified. Alternatively, in Embodiments 1 to 3, any constituent element may be omitted.

The embodiments described above are essentially preferable examples and are not intended to limit the scope of the present disclosure, the scope of applications of the present disclosure, and the scope of uses of the present disclosure. The embodiments described above can be modified in various ways as necessary.

### REFERENCE SIGNS LIST

11, 11b : satellite constellation forming unit; 20: satellite constellation; 21: orbital plane; 30: satellite; 31: satellite control device; 32: satellite communication device; 33: propulsion device; 34: attitude control device; 35: power supply device; 55: orbit control command; 60: space object; 70: Earth; 300: satellite group; 600: satellite constellation forming system; 700: ground facility; 510: orbit control command generation unit; 520: analytical prediction unit; 909: electronic circuit; 910: processor; 921: memory; 922: auxiliary storage device; 930: input interface; 940: output interface; 950: communication device; R: passage region; 40: business device; 41: mega-constellation business device; 42: LEO constellation business device; 43: satellite business device; 44: orbital transfer business device; 45: debris removal business device; 46: rocket launch business device; 47: SSA business device; 800: OADR; 801: database; 802: server; 81: first database; 82: second database; 83: control unit.

1. A satellite constellation forming system to form a satellite constellation having a plurality of orbital planes in each of which a plurality of satellites fly at a same average orbital altitude, the satellite constellation forming system comprising
processing circuitry to form a passage region for a space object to pass through at an orbital altitude of the satellite constellation by controlling a relative angle in an azimuth direction between orbital planes of the plurality of orbital planes before the space object passes through the orbital altitude of the satellite constellation from above the satellite constellation, and after the space object has passed through the passage region, restore the satellite constellation to a state before the passage region is formed by restoring the relative angle in the azimuth direction between orbital planes of the plurality of orbital planes.

2. The satellite constellation forming system according to claim 1,
wherein the processing circuitry forms the satellite constellation in which each orbital plane of the plurality of orbital planes passes through a polar region and the polar region is a region congested with orbital planes, and forms, as the passage region, a region resulting from enlarging a space between orbital planes through which the space object is to pass among the plurality of orbital planes.

3. The satellite constellation forming system according to claim 1,
wherein the processing circuitry forms the satellite constellation in which each orbital plane of the plurality of orbital planes does not pass through a polar region and a mid-latitude region is a region congested with orbital planes, and forms, as the passage region, a region where a density of orbital planes is alleviated in the mid-latitude region.

4. The satellite constellation forming system according to claim 1,
wherein the processing circuitry narrows the relative angle in the azimuth direction between orbital planes of the plurality of orbital planes so as to form the passage region by simultaneously changing orbital altitudes of all satellites in orbital planes located. adjacently and maintaining a state in which average orbital altitudes of the plurality of orbital planes arranged in the azimuth direction are raised in a sequential order, and restores the relative angle in the azimuth direction between orbital planes of the plurality of orbital planes so as to restore the satellite constellation to a state before the passage region is formed by maintaining a state in which the average orbital altitudes of the plurality of orbital planes arranged in the azimuth direction are lowered in a sequential order.

5. A satellite constellation forming method of a satellite constellation forming system to form a satellite constellation having a plurality of orbital planes in each of which a plurality of satellites fly at a same average orbital altitude, the satellite constellation forming method comprising
forming a passage region for a space object to pass through at an orbital altitude of the satellite constellation by controlling a relative angle in an azimuth direction between orbital planes of the plurality of orbital planes before the space object passes through the orbital altitude of the satellite constellation from above the satellite constellation, and after the space object has passed through the passage region, restoring the satellite constellation to a state before the passage region is formed by restoring the relative angle in the azimuth direction between orbital planes of the plurality of orbital planes.

6. (canceled)

7. A ground facility included in a satellite constellation forming system to form a satellite constellation having a plurality of orbital planes in each of which a plurality of satellites fly at a same average orbital altitude, the ground facility comprising
processing circuitry to form a passage region for a space object to pass through at an orbital altitude of the satellite constellation by controlling a relative angle in an azimuth direction between orbital planes of the plurality of orbital planes before the space object passes through the orbital altitude of the satellite constellation from above the satellite constellation, and after the space object has passed through the passage region, restore the satellite constellation to a state before the passage region is formed by restoring the relative angle in the azimuth direction between orbital planes of the plurality of orbital planes.

8. A business device of a business operator that manages a satellite constellation, the business device of the business operator that manages a satellite constellation comprising the satellite constellation forming system according to claim 1.

9. A business device of a business operator that manages a space object, the business device of the business operator that manages a space object causing a business operator that manages a satellite constellation to execute the satellite constellation forming method according to claim 5.

10. An open architecture data repository comprising a database to store orbit information of a space object and a server, the open architecture data repository disclosing orbit information of a space object,
wherein the server causes a business operator that manages a satellite constellation to execute the satellite constellation forming method according to claim 5, based on orbit information of a space object acquired from a business device of a business operator that manages the space object, a debris removal business device, or an SSA business device.

11. The satellite constellation forming system according to claim 2,
wherein the processing circuitry narrows the relative angle in the azimuth direction between orbital planes of the plurality of orbital planes so as to form the passage region by simultaneously changing orbital altitudes of all satellites in orbital planes located adjacently and maintaining a state in which average orbital altitudes of the plurality of orbital planes arranged in the azimuth direction are raised in a sequential order, and restores the relative angle in the azimuth direction between orbital planes of the plurality of orbital planes so as to restore the satellite constellation to a state before the passage region is formed by maintaining a state in which the average orbital altitudes of the plurality of orbital planes arranged in the azimuth direction are lowered in a sequential order.

12. The satellite constellation forming system according to claim 3,
wherein the processing circuitry narrows the relative angle in the azimuth direction between orbital planes of the plurality of orbital planes so as to form the passage region by simultaneously changing orbital altitudes of all satellites in orbital planes located adjacently and maintaining a state in which average orbital altitudes of the plurality of orbital planes arranged in the azimuth direction are raised in a sequential order, and restores the relative angle in the azimuth direction between orbital planes of the plurality of orbital planes so as to restore the satellite constellation to a state before the passage region is formed by maintaining a state in which the average orbital altitudes of the plurality of orbital planes arranged in the azimuth direction are lowered in a sequential order.

13. A business device of a business operator that manages a satellite constellation, the business device of the business operator that manages a satellite constellation comprising the satellite constellation forming system according to claim 2.

14. A business device of a business operator that manages a satellite constellation, the business device of the business operator that manages a satellite constellation comprising the satellite constellation forming system according to claim 3.

15. A business device of a business operator that manages a satellite constellation, the business device of the business operator that manages a satellite constellation comprising the satellite constellation forming system according to claim 4.

16. A business device of a business operator that manages a satellite constellation, the business device of the business operator that manages a satellite constellation comprising the satellite constellation forming system according to claim 11.

17. A business device of a business operator that manages a satellite constellation, the business device of the business operator that manages a satellite constellation comprising the satellite constellation forming system according to claim 12.

18. A business device of a business operator that manages a satellite constellation, the business device of the business operator that manages a satellite constellation comprising the ground facility according to claim 7.
